(19) United States
(12) Patent Application Publication
(10) Pub. No.: US 2015/0261405 A1
(43) Pub. Date: Sep. 17, 2015

(54) Methods Including Anchored-Pattern Data Entry And Visual Input Guidance

(71) Applicant: Lynn Jean-Dykstra Smith, Minneapolis, MN (US)

(72) Inventor: Lynn Jean-Dykstra Smith, Minneapolis, MN (US)

(21) Appl. No.: 14/214,551

(22) Filed: Mar. 14, 2014

(51) Int. Cl. G06F 3/0488

(52) U.S. Cl. CPC G06F 3/0488

(57) ABSTRACT

In general, computer-implemented methods relating to anchored data entry are provided. Methods may include storing the location of a held indication (e.g. thumb held on a surface) as an anchor. In some embodiments, methods may evaluate for data entry by comparing the locations of indications within a set of indications (e.g. several touches on a tablet) for match to a pattern type and then evaluate the indication set's location as a whole relative to the anchor. Methods may allow typing and visual guides to move with the hand.

Methods may include creating an anchor in response to a predetermined indication of the user. The methods described herein may be applied to any type of data entry. For example, touching buttons on a touch-surface wall temperature control panel. Methods may include evaluating indications for a match to a pattern. Systems and machine-readable media are also provided.

This application claims the benefit of U.S. Provisional Patent Application No. 61/782,021, filed Mar. 14, 2013, by the present inventor, the entire content of which is hereby incorporated by reference.

### BACKGROUND

Data entry concerning buttons and keyboard keys, even on chording keyboards, is a process where the user attempts to recognize the location of a key(s) and then attempts to touch the key(s) to input data.

Commonly, software that evaluates data entry for virtual keyboards or virtual buttons uses a fixed key referenced at the time of evaluating a key press or button press against indications (e.g. touches on a virtual keyboard on a tablet) to determine data entry.

Typing on virtual keyboard has many well-established issues. For example, it requires a lot of looking at the keyboard. Typing on a virtual keyboard can be a slow and error-prone experience for many users, for example, due to the cramped size and spacing of the virtual keys included on a virtual keyboard, as well as the lack of tactile feel or feedback provided by the virtual keyboard, which assists the act of finding keys. Attempting to touch inside a key can be difficult because it requires the user to orient thinking to where a key is on a screen or physical device. Methods to better interpret user interactions with virtual data input would facilitate user interaction with computing devices.

In contrast, patterning orients thinking to placing the hand in a certain position. Patterning does not rely on fixed key areas. In physical chording keyboards, by nature of the keyboard being physical, the user must hit an area (i.e. a key). Multi-touch-sensitive surfaces allow us to detect touch locations in a new way, so we can truly break free from having to hit on or relative to a key area.

The same pattern can be evaluated successfully even when performed with a hand that naturally changes position over time. The hand may naturally drift while typing or fingers may sometimes fall a little more or less expanded. The fingers and hand may shift as a body position is shifted. The user may have their hand resting on the low outside of their thigh while sitting, and may touch a pattern close in to a thumb held against the thigh, then shift and touch the same pattern further away from their thumb. Software can be written, when using detections from a touch-sensitive surface, to recognize both of these touch patterns as the same, and thus output the same text character. The same pattern is recognized, as a whole, when fingers fall high or low of specific strike area. Evaluating patterns on a touch-surface does not require patterns to be positioned with the exact nature of evaluating touches for hitting a key area. Allowing a user to simply let their hand fall anywhere on a patch on the fabric of pants in the thigh area of a lap while sitting is a very natural and ergonomic place to start with typing. Not requiring a user to look down to even place the hand could be preferable to putting hands on fixed keys. If a user were to lift their four fingers, after placing all five digits on a surface and then experiment with the natural drop of the fingers while their thumb is held, they could create an arch of touches that changes to be bigger or more close in as the fingers are stretched. This is a very natural feeling motion.

Concepts in this disclosure may relate in part to realizing that decoupling the act of displaying keys on a visual guide from the act of evaluating indications for command signals based on keys allows for creating different methods of data entry. Software could be written for touch-sensitive surfaces wherein keys are shown but are not used in touch evaluation in data entry. Evaluating information such as the location of a hand, fingers, finger motion, skew between fingers, width between fingers, etc., allows input indications to be evaluated against the concept of a likely deformation state of the fingers during a touch. This information relates to the intended pattern of the user, rather than the user's success, or lack thereof, in touching inside a key area. With a touch surface, the user may think of making patterns as intending to hit one or more keys, while at the same time, software could evaluate their indications for relativity to a hand-based anchor. This realization may lead to thinking about methods that support orienting evaluating patterns expressed rather than keys hit, even when the user is single-tap data entry indicating.

### SUMMARY

In one implementation, a method, performed by a computing device operably coupled to at least one presence-sensitive component may include defining, by the computing device, an anchor based on data received by a presence-sensing component, comprising, at least in part, data relating to the location of a held indication on a surface wherein the held indication is performed by a hand, receiving, by a presence-sensitive component, a set of input indications from the user, identifying, by the computing device, a pattern by evaluating the set of input indications, based, if the set has more than one indication, at least in part, on spatial relation of input indications within the set of input indications, and evaluating based, at least in part, upon spatial relation of the set of input indications to the anchor, identifying, by the computing device, a command signal that corresponds to the pattern, performing, by the computing device, an action based on said command signal.

Additionally, the anchor may comprise data relating to one or more of the following: size of the hand and size relating to input indications.

Additionally, the method may further comprise a visual guide that appears on a display and which corresponds to the user's hand location, and wherein the position of the visual guide is based, at least in part, on anchor data.

Additionally, the a visual guide may appear on a different surface than the surface where the indication sets are performed and wherein the position of the visual guide and/or the visual display of the visual guide corresponds to the performance of the indication sets by the user's hand.

Additionally, the method may further comprise a visual guide appears under the user's hand, and wherein the position of the visual guide is based, at least in part, on anchor data and wherein the visual guide overlaps displayed content.

Additionally, the held indication or the set of indications may be indicated, at least in part, on an area of displayed content.

Additionally, at least part of the computing device may be integrated into or intended to be used in conjunction with clothing;

Additionally, the method may further comprise identifying, based on data received by a presence-sensitive component, an indication set comprised of data relating to one or more digits touching a surface followed by all touches except one ending wherein the computing device triggers a command signal to initiate data entry in response to the identifying.

Additionally, the set of indications corresponding to placements of the user's hand intended to convey, conceptually, chorded typing wherein the main pattern set is based on one of the following: a two row and three column grid, a three row and three column grid, a three row grid that utilizes a QWERTY concept.

In another implementation, a method, performed by a computing device operably coupled to at least one presence-sensitive component may include defining an anchor, by the computing device, based on data received by a presence-sensing component, comprising, at least in part, data relating to the location of a held indication on a surface wherein the held indication is performed by a hand detecting, by the computing device, based on data received by a presence-sensing component, a change of the held indication, updating the anchor, by the computing device, based on data relating to a change of the location of the hand, identifying, by the computing device, one or more input indications evaluated to correspond with a command signal, performing an action, by the computing device, based on said command signal.

Additionally, anchor may comprise data relating to one or more of the following: size of the hand and size relating to input indications.

Additionally, a visual guide may appear under the user's hand, and wherein the position of the visual guide is based, at least in part, on anchor data and wherein the visual guide moves location corresponding to anchor location changes.

Additionally, updating the anchor may be based on the change of the held indication.

Additionally, the method may further comprise identifying an indication set, based on an indication set comprised of one or more digits touching a surface followed by all touches except one lifting and using the the location of the remaining held indication and wherein defining the anchor is based, at least in part, on the identified indication set.

In another implementation, a method, performed by a computing device operably coupled to at least one presence-sensitive component may include defining an anchor, by the computing device, based on data received by a presence-sensing component, comprising, at least in part, data relating to the location of a held indication on a surface wherein the held indication is performed by a hand, receiving, by a presence-sensitive component, a set of input indications from the user, identifying, by the computing device, a pattern by evaluating the set of input indications, based, if the set has more than one indication, at least in part, on spatial relation of input indications within the set of input indications, and evaluating based, at least in part, upon spatial relation of the set of input indications to the anchor, identifying, by the computing device, a command signal that corresponds to the pattern, performing, by the computing device, an action based on said command signal, detecting, by the computing device, based on data received by a presence-sensing component, a change of the held indication, updating, by the computing device, the anchor, based on data relating to the change of the held indication.

Additionally, the anchor may comprise data relating to one or more of the following: size of the hand and size relating to input indications.

Additionally, a visual guide may appear under the user's hand, and wherein the position of the visual guide is based, at least in part, on anchor data.

Additionally, a visual guide may appear on a different surface than the surface where the indication sets are performed and wherein the position of the visual guide and/or the visual display of the visual guide corresponds to the performance of the indication sets by the user's hand.

Additionally, the held indication or the set of indications may be indicated, at least in part, on an area of displayed content.

Additionally, at least part of the computing device may be integrated into or intended to be used in conjunction with clothing.

Additionally, the method may further comprise identifying, based on data received by a presence-sensitive component, an indication set comprised of one or more digits touching a surface followed by all touches except one lifting and storing the location of the remaining held indication in the anchor.

Additionally, updating the anchor may be based on input indications in the indication sets rather than data relating to the change of the held indication.

Additionally, the pattern evaluation may include first determining a pattern type then determining the pattern based, at least in part, on the location of the pattern as a whole to the anchor, and wherein the pattern evaluation is made without regard of direct comparison of the the individual indications to the anchor.

Additionally, defining the anchor may be based on a physical location on the presence-sensitive panel, without regard to data received by a presence-sensing component.

Additionally, the set of indications may corresponds to placements of the user's hand intended to convey, conceptually, chorded typing wherein the main pattern set is based on one of the following: a two row and three column grid, a three row and three column grid, a three row grid that utilizes a QWERTY concept.

In another implementation, a method, performed by a computing device operably coupled to at least one presence-sensitive component integrated into clothing, the method may include defining, by the computing device, an anchor based on data received by a presence-sensing component, comprising, at least in part, data relating to the location of a held indication on a surface wherein the held indication is performed by a hand, receiving, by a presence-sensitive component, a set of input indications from the user, identifying, by the computing device, a pattern by evaluating the set of input indications, based, if the set has more than one indication, at least in part, on spatial relation of input indications within the set of input indications, and evaluating based, at least in part, upon spatial relation of the set of input indications to the anchor, identifying, by the computing device, a command signal that corresponds to the pattern, performing, by the computing device, an action based on said command signal.

Additionally, the method may further comprise a visual guide that appears on a display and which corresponds to the user's hand location, and wherein the position of the visual guide is based, at least in part, on anchor data.

Additionally, the method may further comprise identifying, based on data received by a presence-sensitive component, a set of indications comprised of data relating to one or more digits touching a surface followed by all touches except one ending wherein the computing device triggers a command signal to initiate data entry in response to the identifying.

Additionally, the method may further comprise identifying, based on data received by a presence-sensitive component, an indication set comprised of one or more digits touching a surface followed by all touches except one lifting and using the the location of the remaining held indication in defining the anchor.

Additionally, the anchor may be defined based on a physical location on the presence-sensitive panel, without regard to data received by a presence-sensing component.

Additionally, the anchor may comprise data relating to one or more of the following: size of the hand and size relating to input indications.

Additionally, a visual guide appears may appear under the user's hand, and wherein the position of the visual guide is based, at least in part, on anchor data and wherein the visual guide moves location corresponding to anchor location changes.

Additionally, the method may further comprise updating, by the computing device, the anchor, based on data relating to the change of the held indication.

Additionally, the set of indications may correspond to placements of the user's hand intended to convey, conceptually, chorded typing wherein the main pattern set is based on one of the following: a two row and three column grid, a three row and three column grid, a three row grid that utilizes a QWERTY concept.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

The details of one or more aspects of the disclosure are set forth in the accompanying drawings and the description below. Other features, objects, and advantages of the disclosure will be apparent from the description and drawings, and from the claims.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram illustrating exemplary implementations of the systems and methods described herein;

FIGS. 2A-D are diagrams illustrating exemplary implementations of the systems and methods described herein;

FIG. 3 is a diagram illustrating exemplary implementations of the systems and methods described herein;

FIG. 4 illustrates a simplified block diagram of a computer system implementing one or more embodiments of the present invention.

FIG. 5 is a diagram illustrating exemplary implementations of the systems and methods described herein;

FIGS. 6A-6C are diagrams illustrating exemplary implementations of the systems and methods described herein;

FIGS. 7A-7H are diagrams illustrating exemplary implementations of the systems and methods described herein;

FIGS. 8A-8E are diagrams illustrating exemplary implementations of the systems and methods described herein;

FIG. 9 is a diagram illustrating exemplary implementations of the systems and methods described herein;

FIG. 10 is a diagram illustrating exemplary implementations of the systems and methods described herein;

FIGS. 11A-11D are diagrams illustrating exemplary implementations of the systems and methods described herein;

### DETAILED DESCRIPTION

The following detailed description refers to the accompanying drawings. The same reference numbers in different drawings may identify the same or similar elements. Also, the following detailed description does not limit the invention. All statements in the detailed description refer to one or more possible embodiments of the invention.

The term “visual guide”, as used herein, may refer to displaying visual information on a surface that is related to the location of the anchor. The visual guide may assist the user in data entry. In some embodiments, the visual guide may display keys to guide the user. In some embodiments, the visual guide may display keys to guide the user while not using any key information in determining patterns. In some embodiments, when the anchor moves position, the visual guide moves with it without regard to whether the user actively touching patterns at the time. The visual guide may appear under the user's hand when she pattern-touches the correct indication configuration to indicate anchor instantiation. The visual guide may appear under the user's hand when she pattern-touches the correct indication configuration to indicate visual guide instantiation. In one example, a visual guide that displays keys might follow an arc for natural finger placement to better fit the user's hand. The visual guide could adjust size as the anchor changes its size information. In one example, the visual guide may show on the display of a user's desktop computer as the user indicates on a device integrated into their clothing. The visual guide is not required to update every time the anchor updates.

The term “input-allowable area”, as used herein, may refer to an area of a surface wherein the user may perform indications for evaluation as data entry. The input allowable area may be predetermined or determined by the program that evaluates for data entry. In some embodiments, an input-allowable area will have at least one defined area of a surface wherein input indications (e.g. touches) will be evaluated for the methods (e.g. an indication set matching to a pattern) described in this disclosure. For example, the input-allowable area may be the full detectable surface of a touch-sensitive panel or it may be one or more parts of a touch-sensitive panel. The input-allowable area may refer to multiple surfaces. The input-allowable area may exist on more than one surface. The input-allowable area may exist on more than one device. The input-allowable area may be more than one area on the same surface. The input-allowable area may be overlaid on displayed content. The input-allowable area may be one or more physically based or virtual locations or any combination thereof. The input-allowable area may, in one example, be defined as all data that one or more presence-sensitive device detects. In some embodiments, the presence-sensitive component may detect input indications relative to a virtual surface or virtual plane. Input-allowable areas may exist relative to or on virtual constructs.

As used herein, the term “input indication” may refer to the detection of movement (e.g. a touch on a touch-sensitive panel) of an indicating object (e.g., a finger, pointing device, soft stylus, pen, etc.) on or relative to a surface. Input indications may relate to a virtual surface or virtual plane determined by software. In some embodiments, an indication may be deemed to have occurred if a sensor detects a touch, by virtue of the proximity of the deformable object (e.g. finger) to the sensor, even if physical contact has not occurred. An example input indication might be a finger touch on a touch-sensitive surface that is used to evaluate against a pattern. An example input indication may be a touch that is held as an anchor point.

As used herein, the term “indication set” may refer to one or more indications grouped relative to a span of time. An indication set can include any combination of indications. An indication set may be multiple fingers touching at the same time (e.g. multitap, multitouch). An indication may include any type of touch or gesture (e.g. finger swipe down, arc, double arc, longpress, flick, chord). An indication set may contain compound or complex indications (e.g. finger down and then a circle). An indication set may refer to one single indication. An indication set may comprise any type of indication or any combination of type of indications performed relative to a span of time. In some embodiments, indication sets are evaluated for probability of matching a pattern.

The term “presence-sensitive component”, as used herein, may refer to a sensor, touch-sensitive panel, touch-sensitive display, or any combination thereof. The term may refer to a plurality of components. The term may refer to a plurality of presence-sensitive components. For example, “presence-sensitive component” may refer to a sensor (e.g. a motion sensor, 3d sensor, video camera, a capacitive screen, a near field screen, depth sensor, etc.) attached to, within, or communicating with a computing device. In another example, the presence-sensitive component may refer to the touch-sensitive display of a tablet device. The presence-sensitive component may detect input indications relative to a virtual surface or virtual plane. The presence-sensitive component may signal an indication (e.g. touch) when the indication object (e.g. finger) is contacting a surface (e.g. touch-sensitive display surface) or by detecting one or more positions relative to, but not contacting, a surface.

Also, as used herein, the use of the term “presence-sensitive component” or “touch-sensitive panel” is not intended to limit the means by which touches may be detected relative to a physical or virtual surface. For example, a separate sensor that senses objects may detect indications occurring on an implied surface (e.g. virtually defined flat plane in the air, etc.) that doesn't physically exist. In some examples, a touch-sensitive panel may have a display. In some examples, a presence-sensitive component or touch-sensitive panel might be flexible (e.g. moves like fabric, bendable plastic, cardboard). In one example, the presence-sensitive device could be woven into fabric or be part of clothing or be a patch applied to clothing.

The particulars of sensing the indication (e.g. touch) functionality as such is not a key aspect of the present invention, and no detailed description is given herein to avoid obscuring the invention in unnecessary detail.

The term “character”, as used herein, is intended to encompass, but not be limited to, a symbol or other figure that may be entered by the individual. Examples of characters include alphabetic characters, whether from the Roman, Cyrillic, Arabic, Hebrew, or Greek alphabets, for example. Furthermore, a character may be a numeral, a punctuation mark, or one of the various symbols that are commonly utilized in written text, such as $, #, %, &, or @, for example. In addition, a character may be one of the various symbols utilized in Asian languages, such as the Chinese, Japanese, and Korean languages. Groups of various characters that form words or word-type units are hereby defined as a text unit.

The term “key”, as used herein, may refer to the conventional concept of a key on a physical or virtual keyboard. Keys on a virtual keyboard are at a fixed location at the time of evaluating key presses. Some virtual keyboards treat keys as a location point rather than a key with an area defined by boundaries. As used herein, references to ‘key’ or ‘key area’ may also cover the concept of ‘key points.’ The relation to a fixed location of the key at the time of input analysis is conceptually similar between these two concepts. In general, virtual keys and virtual buttons function in a similar manner.

The term “anchor,” as used herein, may refer to data that contains information, at least in part, about a hand. The anchor may relate to the location (e.g. coordinates) and/or position of the user's hand. The anchor may contain data about the location of a digit touching a surface, which may be a held indication. The anchor may, at least in part, comprise information related to size (e.g. length of touch span, average width of a series of touches, left-side border length that corresponds to the left hand pinkie's range of motion).

As used herein, “held indication” refers to an indication by the user that is not completed. For example, a thumb held on a surface while a user is using fingers to type. The thumb may move, but the indication is not completed by moving. Until the thumb is lifted, it is a held indication. A held indication may be the user placing their hand inside a presence-detectable 3D area.

As used herein, “pattern set” may refer to group of patterns comprising one or more patterns. Pattern sets may be comprised of one or more pattern types such as multifinger taps, double taps, single taps, swiping, double finger gestures, complex tapping of holding one finger and double tapping another, a combination of a flick down and a single touch, triple taps. Pattern sets may mix pattern types that relate to and anchor and pattern types that do not relate to an anchor.

The term “pattern”, as used herein, may refer to data, stored on the computing device, that contains information that can be used, at least in part, to evaluate indications for a match. Patterns may correspond to the likely hand deformation expressed by one or more indications. Patterns may correspond to the likely hand deformation expressed by one or more indications when evaluated against an anchor. Patterns, for example, may include a single touch, a chord (e.g. multiple touches at one time in a particular spatial configuration), a gesture, a swipe (e.g. one-direction elongated touch), a flick, a pinch, double touches (i.e. two quick touches by the same finger or fingers), double-gesturing, or; or any combinations thereof. For example, a pattern may describe an indication set of a gesture swipe down by the index finger followed by a single touch at the end of the swipe by the index finger. For this pattern, the corresponding pattern type might be ‘a swipe down followed by a single touch at the end of the swipe.’ Methods described herein, in some embodiments, may first identify a pattern type and then determine the digits performing the pattern by evaluating the pattern's location, as a whole, to the anchor. In some embodiments, comparing the indication set's spatial relation to the anchor while selecting a pattern may use individual indications within the set of indications in the analysis, and might not use the set of indications as a whole.

### Overview

Keys on a physical keyboard are placed at a fixed area and location by virtue of being physical. The paradigm of physical keys moved to the surface of presence-sensitive devices (e.g. touch-sensitive tablets) as virtual keyboards. The paradigm of keys on a virtual keyboard is one where keys are fixed at a defined location and have a fixed area, usually within a defined keyboard area, which is displayed as a keyboard with keys to the user. Buttons on panels (e.g. wall temperature control panel buttons) function in a similar manner. In most cases, the algorithms evaluating for data entry on virtual keyboards and virtual button panels rely on a key's position for successful detection of keyed data entry. Further, virtual buttons use algorithms that rely on a button's location at the time of a touch to detect the user hitting the button. For example, on a virtual keyboard, user touches are evaluated against fixed key positions for a successful keypress and corresponding character or word entry. This ‘find the fixed key or button’ paradigm puts a limitation on data input methods.

The realization that a virtual surface doesn't require touching inside a defined key area to allow users to enter characters, but rather can require touching relative to a key area, has been explored at length as a solution to the problems associated with typing on virtual keyboards. There have been a lot of attempts to improve data entry by better placement of keys on a surface.

Notable examples include the Virtual Keyboard (U.S. Pat. No. 20130275907 to Hannes Lau, Christian Sax), uses a model of the hand to determine wrist angle and better place keys. This patent states keys “are still activated if the sensed touch is close to a key,” and is clearly intending the keys mapped to the surface to be used in the evaluation of sensed touches.

The Adaptive Virtual Keyboard (U.S. Pat. No. 20130257732 to Robert Duffield) is another similar example exploring the idea of better key placement.

These two previous keyboard improvements may better account for the user touching near the area of the intended key instead of within the key bounds, but fixed keys are still used.

Attempts have been made to use a surface contact to anchor the placement of keys. Notable examples include the Virtual keyboard based activation and dismissal (U.S. Pat. No. 8,619,036 to Timothy J. Mosby, Christian N. Wiswell).

There have been a lot of attempts to solve the ‘missed-key when typing’ issue by methods of contacts that, as a whole, evaluate word prediction. Notable examples include Gestural input at a virtual keyboard (US. Pat. No. 20130249818 to Shumin Zhai, Kun Li).

In the methods disclosed herein, in some embodiments, the act of anchoring may include a surface contact placement (e.g. thumb) that is held while the data entry is being performed. This tracking indication could be a point of reference (e.g. pinkie, hand palm) that is stored as, at least in part, the computers anchor data. The anchor data may be updated as the held tracking indication moves. Any visual guide that is associated with the anchor could be updated when the finger moves to appear to be moving along with the finger.

In one example, an anchor may be the result of sensing data that defines a point corresponding to the midpoint of a finger (e.g. a thumb or pinkie) in contact or near contact with the touch-sensitive surface and store that as a location of the tracking indicator. For example, a user may hold their thumb down while touching or gesturing other patterns. As long as the thumb continues to be held, the location of that touch, which may move, is, at least in part, the anchor.

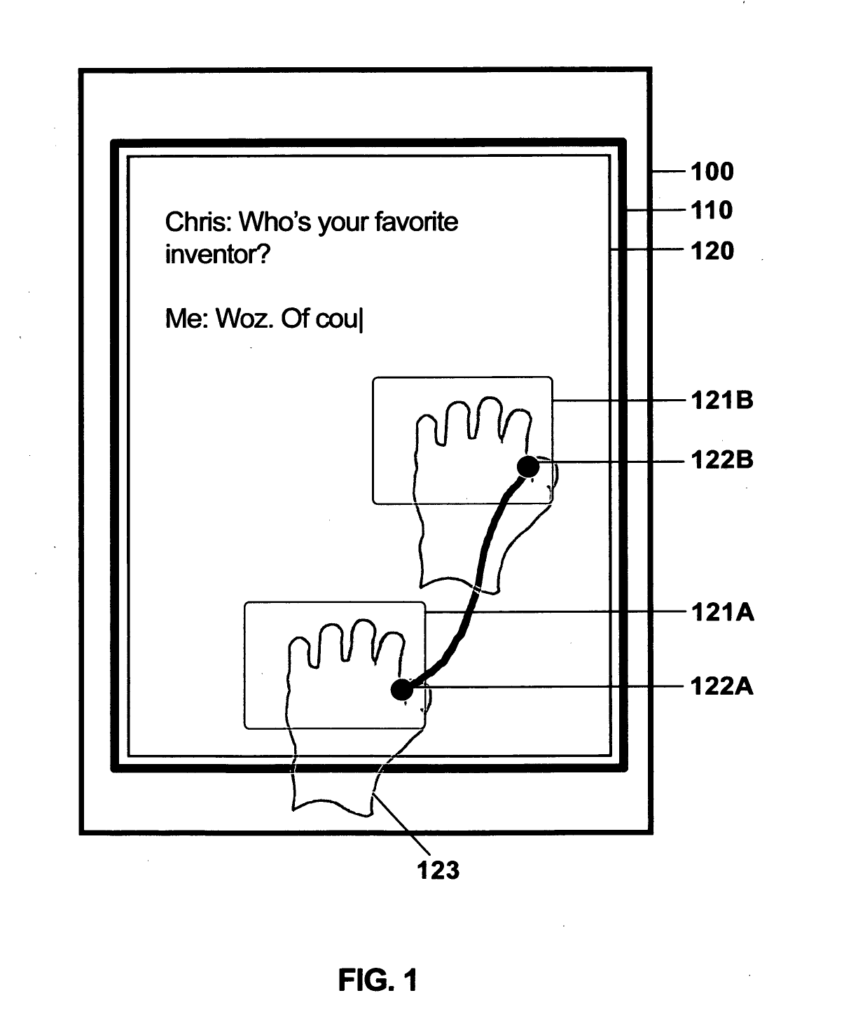

FIG. 1 is a diagram illustrating exemplary implementations of the systems and methods described herein. The diagram illustrates an example of an input-allowable area according to one or more aspects of the present disclosure. As shown in FIG. 1, computing device 100 may include touch-sensitive display 110 and an input-allowable area 120. In this example, the input-allowable area is the full panel. A users hand 123 may contact touch-sensitive display 110 to type on the input-allowable area 120. In this example, there is a held thumb contact, the location of which is stored in the anchor data 122A. The touch-sensitive display 110 may display a visual guide 121A. In this example, the visual guide was triggered to displayed in response to a previous multi touch indication (not shown). As the user moved his thumb, the diagram further illustrates the new position of the held thumb contact location in the anchor data 122B and the visual guide 121, which have changed location corresponding to the move of the held thumb contact 122A/122B.

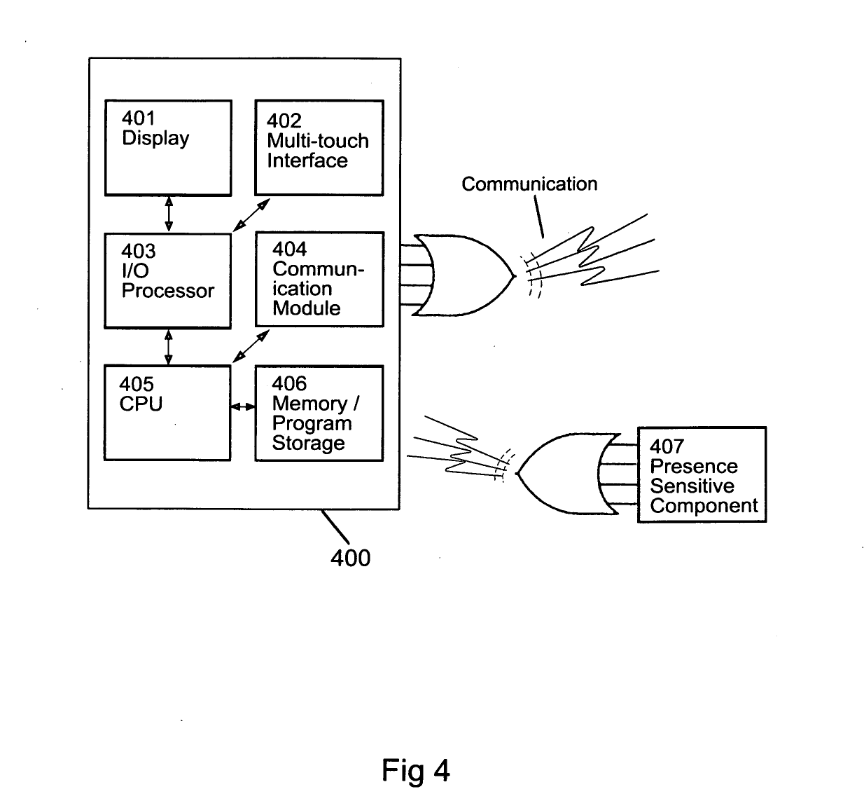

In some examples, computing device 100 may include or may be a part of a mobile computing device (e.g., a mobile phone, smart phone, netbook, laptop, tablet, etc.), a desktop computer, a server system, etc, or any combination thereof. Computing device 100 may also connect to a wired or wireless network using a network interface (not shown). More information on the computing device is described in FIG. 4.

In some embodiments, the anchor may be set by the user indicating a set of indications that corresponds to a computer instruction to set the anchor.

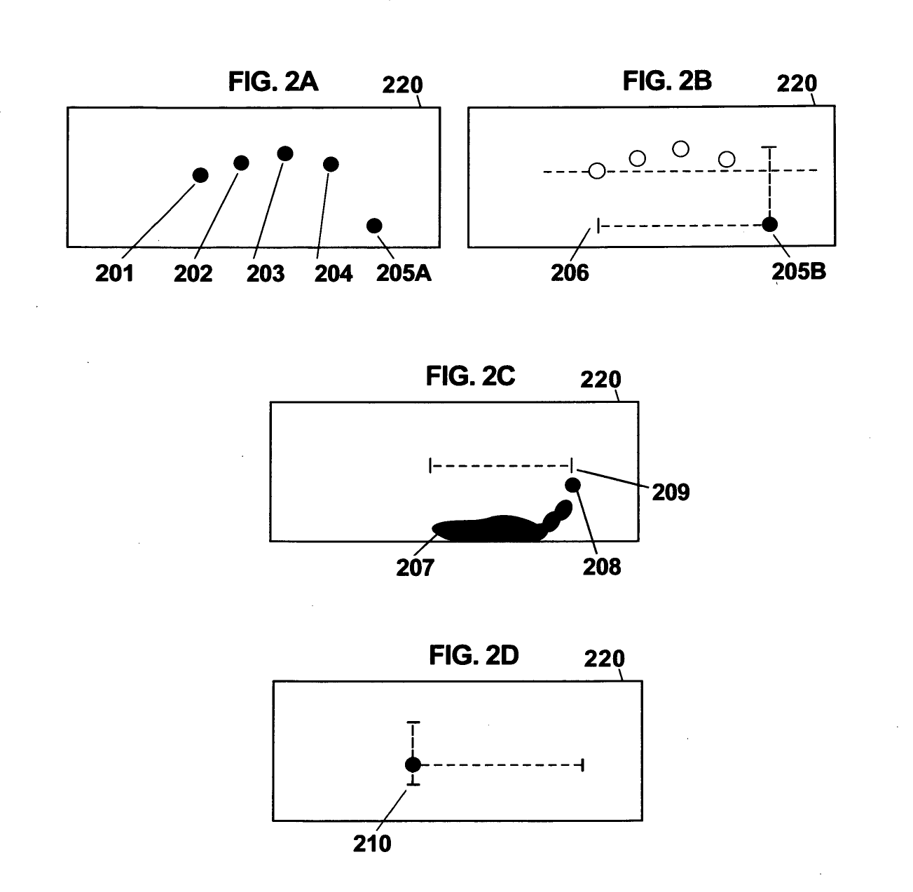

FIGS. 2A-2D are diagrams illustrating exemplary implementations of the systems and methods described herein. These diagrams illustrate three different possible anchor initiation (or reset) examples used by a computing device 100. FIG. 2A shows an embodiment with an input-allowable area 220. In this diagram, the user (not shown) has placed all five digits 201-204, 205A of one hand on a surface. In this example, the configuration of 5 touches on the screen at one time with four lifting have been evaluated to correspond to a control signal to set the anchor data. In this example, this initiating pattern allows subsequent touch patterns to log a character. In the embodiment of FIG. 2B, the user has lifted his fingers, leaving only his thumb 205B, and this triggers the setting of anchor data 206 on the input-allowable area. The anchor data comprises a value for the thumb location, each of the finger locations (shown as empty circles), and a span of the height from the thumb to the highest placed finger, and a span from the thumb to the pinkie touch. The anchor also holds a default value for the use in the calculations as the vertical threshold of a high or low indication set. In this example, that is determined by finding the lower of one of two values −1) defaulting it to ¾ of the way from the thumb to the highest finger or 2) the vertical height of the pinkie touch above the thumb. In this case, it is set as the height of the pinkie touch height above the thumb. In FIG. 2C illustrates an anchor that is set corresponding to a hand palm placed in an input-allowable area 220. In this embodiment, the hand palm contact area 207 and the thumb contact location are stored in the anchor data as a thumb contact location 208 and a span 209 from the left side of the hand palm touch to the location of the thumb. FIG. 2D illustrates an embodiment in which the user configuration for setting the anchor is a double tap with a pinkie that ends in leaving the pinkie held on the surface. In this example, the anchor 210 is stored in the computing device as a location of the pinkie. Also, the anchor in this example includes a vertical span that corresponds to the pinkie location with a bottom buffer to a likely high threshold over which a pattern's center would be evaluated to be in a high-up position. Also, the anchor in this example includes a width span relating to a touch span width that had been stored on the computing device in a previous session of typing by the user.

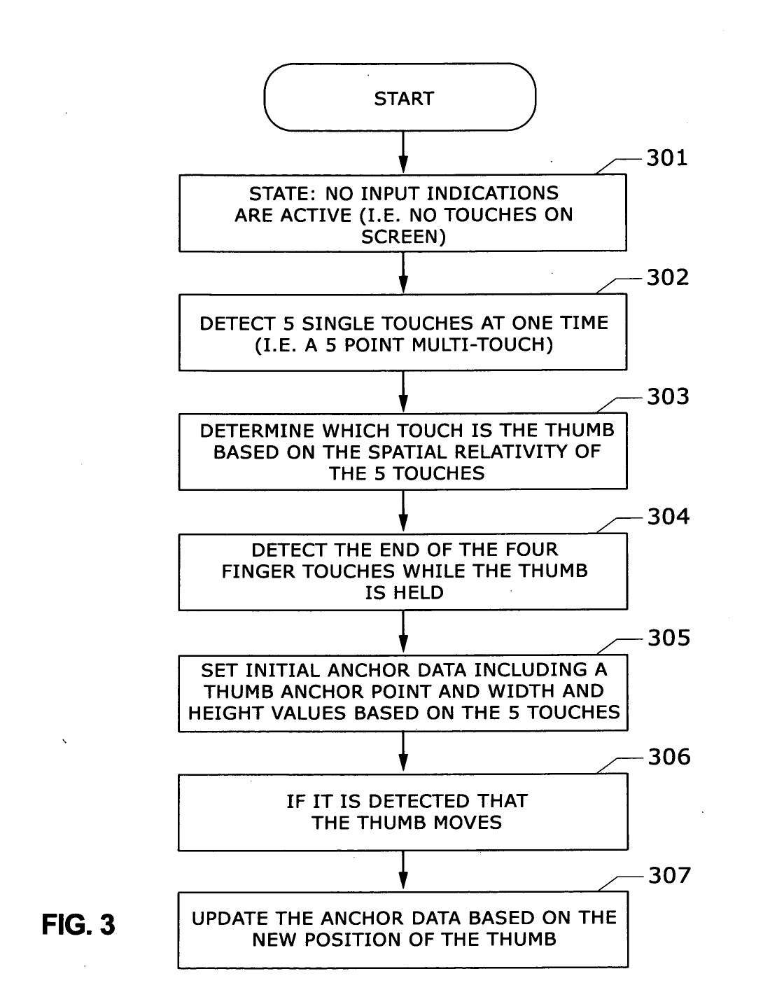

FIG. 3 illustrates an exemplary process for defining anchor data on a computing device 100 and updating the anchor data in the event the hand moves the anchor digit according to certain aspects of the disclosure. In the start of this example, there are no touches on the surface of an area that is being used by the presence-sensitive component for entering data 301. There are 5 touches detected as contacting the screen simultaneously 302 and the application determines which touch is the thumb based on the spatial relativity of the 5 touches 303 and detects the end of the four finger touches while the thumb is held 304. The application sets anchor data including a thumb anchor point and width and height values based on the 5 touches 305. Note that steps 304 and 305 are not dependent on one another in sequence, and may be switched easily in other embodiments. If it is detected that the thumb moves 306, then the application updates the anchor data based on the new position of the thumb 307.

An example computer system that can implement the methods described above is illustrated in the simplified schematic of FIG. 4. The program may be stored in a memory 406 of the computer system, including solid state memory (RAM, ROM, etc.), hard drive memory, or other suitable memory. CPU 405 may retrieve and execute the program. CPU 405 may also receive input through a multi-touch interface 402 (i.e. a presence-sensitive component) or other input devices not shown. In some embodiments, I/O processor 403 may perform some level of processing on the inputs before they are passed to CPU 405. CPU 405 may also convey information to the user through display 401. Again, in some embodiments, an I/O processor 403 may perform some or all of the graphics manipulations to offload computation from CPU 405. Also, in some embodiments, multi-touch interface 402 and display 401 may be integrated into a single device, e.g., a touch screen. Also, in some embodiments, there may not be a display 401. Also, in some embodiments or systems, there may be a display on a coupled device (not shown). In some embodiments or systems, there may be a presence-sensitive component on a coupled device 407. In some embodiments, there may be more components, as this is a simplified diagram. In some embodiments, there may be several devices, for example, two presence-sensitive panels on a pair of pants that each couple to the same a laptop computer. The evaluations described herein could be computed on the pants panels or on the laptop.

The described methods can be used within or in conjunction with a variety of devices, including but not limited to handheld devices that include touch-screen interfaces, devices without a display that include sensing surfaces, desktop computers, tablet computers, notebook computers, handheld computers, personal digital assistants, media players, mobile telephones, televisions, gaming consoles, devices with one or more clothing-integrated sensors, devices that include 3d sensors, 3d sensors, video cameras, external motion sensing devices, and combinations thereof. In one example, a device may be a standalone handheld device with a display. In another example, the device may be a clothing-integrated system that computes the methods described herein internally and sends command signals. In another example, the device may be a clothing-integrated system that sends sensing data to another device for computing the methods described herein.

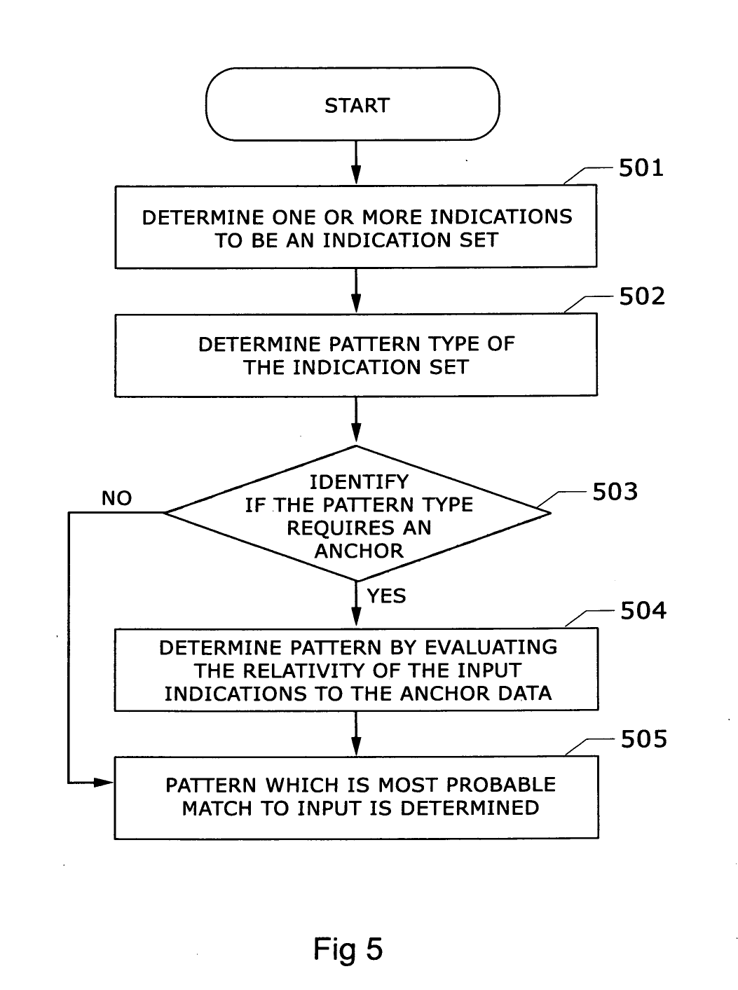

FIG. 5 illustrates an exemplary process for predicting the probability of an indication set corresponding to a pattern on a computing device 100. The first step is to determine one or more indications to be an indication set 501. Next, determine the pattern type of the indication set 502. Identify if the pattern type requires an anchor 504. In some embodiments, in some pattern types, there may not be a requirement for determining the position of the input indication(s) (e.g. gesture) relative to an anchor (e.g. pattern=a gesture of an L shape) in order to determine a pattern 505. In some embodiments, in some pattern types, there may be a need to determine the position of the input indication set relative to the anchor in order to determine the pattern 505 (i.e. pattern=a gesture of an L shape drawn with the ring finger). In some embodiments wherein the process for determining a match of a indication set to a pattern includes determining the position of the indication set, this could be by determining overall input indication set placement or one or more averaged (i.e. using a midpoint) input indication location(s) and comparing that to anchor data.

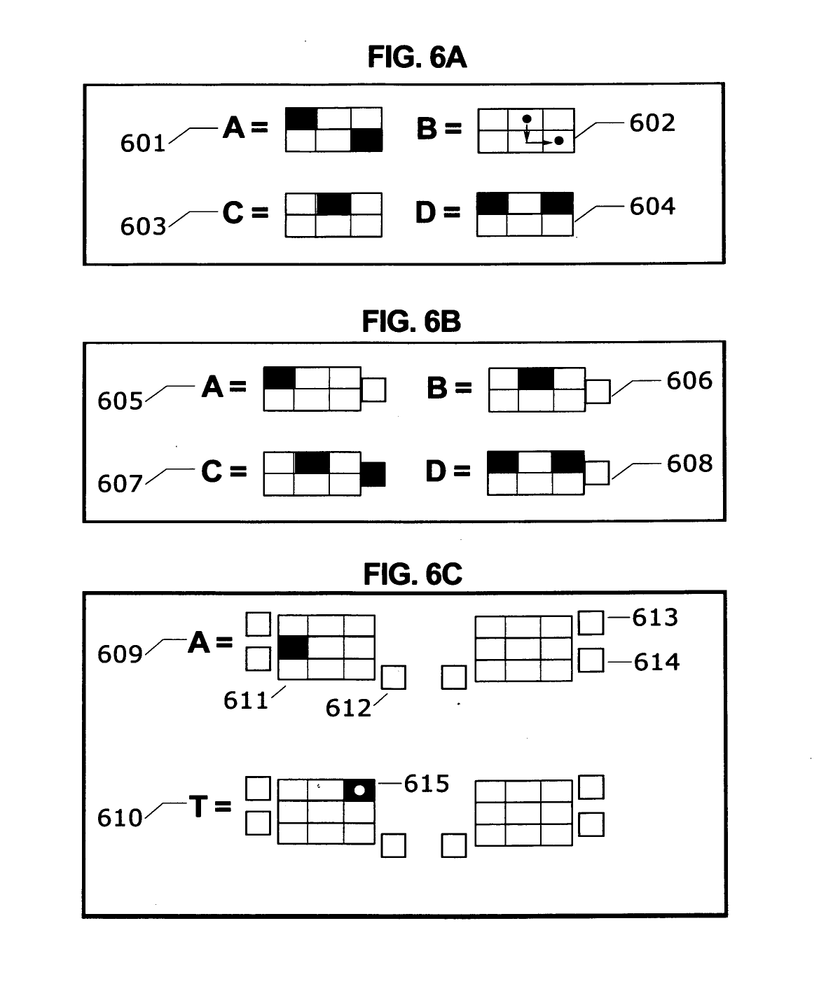

FIGS. 6A to 6C are diagrams illustrating exemplary of the systems and methods described herein. These illustrate pattern charts that may assist the user in learning the finger motions (e.g. input indications) that make patterns. FIG. 6A shows the first four letters of a pattern set of the common alphabet. This example pattern set has 26 letters, but the last 22 are not shown. In this diagram, the intention is for the user to hold their left thumb to a surface and perform chording patterns with three fingers; ring, middle and index. The pattern illustrations are the visual representation of placing these fingers on a two-row and three-column grid. The finger's touches are performed in a high or low fashion to indicate the top or bottom row, respectively. They may conceive of the squares on the grids as keys. The user might conceptualize their touches as attempts to hit keys, rather than placing patterns—keeping with their concept of a physical keyboard or virtual keyboard. This cognitive link may help the user, and does not affect the outcomes of their touches.

The FIG. 6A chart shows four patterns. The pattern for letter A 601 corresponds to a high touch of the left ring finger and a low touch of the index finger at the same time, which would result in an indication set that matches a high/low non-adjacent skewed pattern type. The pattern for letter B 602 instructs an indication of an L gesture performed by the middle finger. The pattern for letter C 603 is for an indication a high single touch of the middle finger. The pattern for letter D 604 is for an indication touching both the index and ring finger at the same time in a high position.

FIG. 6B shows the same concept as FIG. 6A with the addition of a square that instructs the user to place their pinkie on the surface during some pattern expressions. This pattern set uses only pattern types of single and multi-touches The pattern for letter A 605 corresponds to a high touch of the left ring finger and a low touch of the index finger at the same time, which would result in an indication set that matches a high/low non-adjacent skewed pattern type. The pattern for letter B 606 instructs an indication of an L gesture performed by the middle finger. The pattern for letter C 607 is for an indication a high middle finger touch and a pinkie touch at the same time. The pattern for letter D 608 is for an indication touching both the index and ring finger at the same time in a high position.

FIG. 6C shows two patterns corresponding to two letters of a pattern set containing the common alphabet, where the patterning layout is conceptually modeled after a QWERTY keyboard layout. This example pattern set has 26 letters, but 24 are not shown. In this example, the user may be on a device where they set an anchor by placing the heel of the palm on a surface. This leaves all 10 digits free for typing. Another example of placing the anchor might be a non-user-indicated anchor (e.g. no held thumb) wherein data from a separate sensing device (e.g. video camera, motion detector, 3D detector) senses information about the hand (e.g. location and size) and provides the anchor data. In this example, the held indication performed by a hand to define the anchor may be the user holding their hand in the sensing area and indicating relative to a virtual or real surface. Held does not exclude moving. In this diagram, the main character set is expressed in patterns that fit on two main grids of 3 rows and 3 columns. In this example, the three rows correspond to the user placing the height of the finger on the surface in a high, medium and low position relative to the anchor. In the patterning layout for the letter A 609, the grid for the left hand 611 also has a button 612 placed to the right and a little below to indicate when a thumb placement is required. This example patterning layout also has a button 613 to the right of the grid intended for use by the right hand that is intended for a delete function. And, below that, there is a button 614 for use as a return function. The patterning instruction layout for the letter T 610 is the same as the letter A, as these are in the same pattern set. For the user to indicate the letter T, he would double-tap his left hand index finger in a high position. The white circle inside square for button 615 indicates a double tap in this pattern set.

The realization of the ability to analyze touch-sensitive surface information for chorded patterns separately from any visual guide information informs methods where corded patterning does not need to be oriented to evaluating based on fixed key areas. Methods can be derived from the realization you can do non-key area pattern analysis along with displaying a visual guide that shows chorded keys to the user. In some examples, this allows users to develop a conceptual model based on keys, but have the software still not use the key areas in the analysis of input indications.

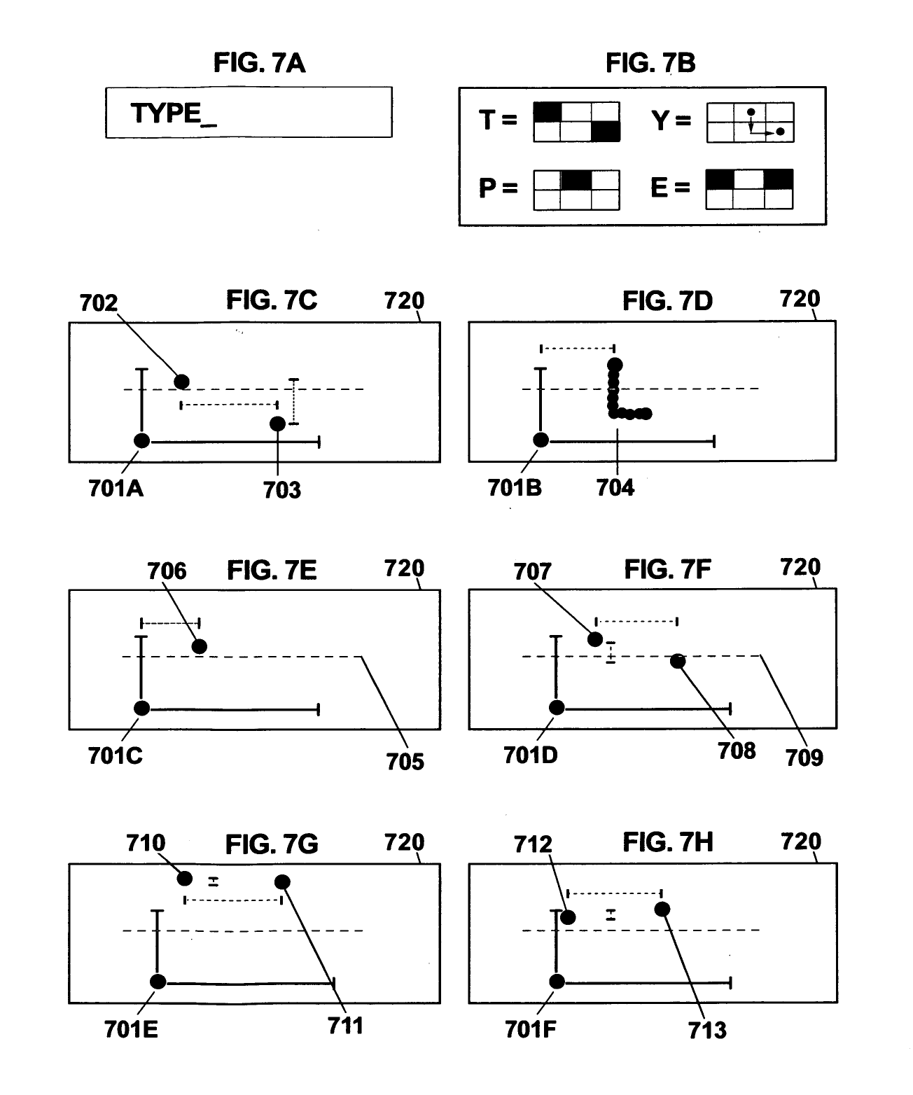

FIGS. 7A to 7H are diagrams illustrating exemplary implementations of the systems and methods described herein. These diagrams illustrate one method of evaluating input indication sets to determine the probability of a match to a pattern. In no way in the evaluations is key data used, even though the diagram visually shows what could be conceived as virtual keys. There is no data relating to the concept commonly known as keys (e.g. fixed surface areas, points or other constructs compared to input for checking if the user has hit on, in, near, or in spatial relation to the area, point or construct) used in the evaluation of patterns. The user is a right-handed person typing into an input-allowable area 720 in this example.

FIG. 7A is an illustration of a text field area on a computing device. They have already established an anchor of a right hand thumb 701A-F. FIG. 7B is an illustration of a pattern set. This pattern set contains four possible patterns. The expression of the letter T in FIG. 7B corresponds to the diagram FIG. 7C. They put their index finger in a stretched (high) position, and their ring finger in a slightly more curved position relative to the index finger curve. They place their index 702 and ring finger 703 on the surface. The presence-sensitive component registers this as a two-point multitouch. Next, the program evaluates the horizontal (e.g. X axis height) distance between the two touches and determines that it is large enough that the fingers are not next to each other. The program evaluates the vertical distance (e.g. Y axis height) between the two touches and determines that it is long enough that the fingers are not intending touches on the same or similar height, but are skewed. The program determines that the left-most touch is the higher of the two. This corresponds to the pattern described visually in FIG. 7B corresponding to a letter T. In some evaluations, the program may number the possible touch positions. If the numbering is going from top left to right along the top column and then from bottom left to right, the program might at some point identify the touches described in 7C as 1, 6.

The expression of the letter Y in FIG. 7B corresponds to the diagram FIG. 7D. In this example, a left handed person is typing with one hand. They put their ring finger in a stretched (high) position, and, holding it down, draws an L shape 704 by dragging down and to the right and then lift the finger. In this example, the program recognizes that an indication set is complete by determining that the only digit left against the surface is the thumb, which is a single digit anchor. The program determines the pattern type to be an anchored L-gesture. Next, the program determines that the initial touchdown of the gesture's distance to the right of the thumb anchor as best matching the distance associated to the ring finger. The pattern is determined to be a ‘ring finger L-gesture’ which in this pattern set corresponds to the letter Y.

The expression of the letter P in FIG. 7B corresponds to the diagram FIG. 7E. In this example, a user puts their ring finger in a stretched (high) position, and touches down and lifts their finger, creating a single touch pattern type 706. The program determines the point of indication as best matching the distance to the right of the thumb associated to the ring finger. The program also identifies the point of indication as being above a threshold 705 for a high-placed pattern. The pattern is determined to be a high single touch of the ring finger, which in this pattern set corresponds to the letter P.

The expression of the letter E in FIG. 7B corresponds to the diagram FIG. 7F. In this example, a user touches the surface with their index 707 and ring fingers 708 in the stretched (high) position, and lifts their finger, creating a multi-touch pattern type of indication set. The program determines the touches to be far enough apart to be two fingers not next to each other and figures out that the touches are the index and ring finger. Next, the program identifies the vertical distance between the two points as being less than what's needed for a skew indication. Compare this to a similar pattern in FIG. 7C, which has a larger vertical height skew, and crosses a value used in determining a definite skew, this illustration does not reach that value amount, thus the fingers are skewed, but not enough to denote intentional skew by the user. It determines the touches to be of a index and ring finger on the same row pattern type. Next, the program compares the midpoint of the vertical distance between the two points as being above a threshold in the anchor 709 for a high-placed pattern. The pattern is determined to be a high multi-touch of the index and ring fingers, which in this pattern set corresponds to the letter E.

Diagram FIG. 7G illustrates an alternate acceptable placement of touches for determining the letter E. In this example, a user touches the surface with their index 710 and ring fingers 711 in the stretched (high) position, and lifts their finger, creating a multi-touch pattern type of indication set. This is the same type of indicated in FIG. 7F, but a different instance of the user performing the motion. Using the same steps as evaluating FIG. 7F, the pattern is determined to be the same pattern—a high multi-touch of the index and ring fingers, which in this pattern set corresponds to the letter E. Note that in this diagram, compared to FIG. 7F, the touches are less skewed vertically, the pattern is set higher. Also, the touches are a little further apart.

Diagram FIG. 7H illustrates an alternate acceptable placement of touches for determining the letter E. In this example, a user touches the surface with their index 712 and ring fingers 713 in the stretched (high) position, and lifts their finger, creating a multi touch pattern type of indication set. This is the same type of indicated in FIG. 7F, but a different instance of the user performing the motion. Using the same steps as evaluating FIG. 7F, the pattern is determined to be the same pattern—a high multi-touch of the index and ring fingers, which in this pattern set corresponds to the letter E. Note that in this diagram, compared to FIG. 7F, the touches are slightly skewed vertically with the index finger lower, and the pattern is set higher than FIG. 7F, but not as high as FIG. 7G. Also, the touches are a further apart, yet the whole pattern is placed a little left of where the pattern fell in FIGS. 7F/7G.

Because of the legacy of keyboards and user's natural inclination to expect to type on keys, the user may think of the typing they perform in FIG. 7C-H as hitting keys on a 3×2 grid keyboard. From the application's point of view, it is not in any way evaluating the touches in relation to keys areas even though the user may be shown a visual guide that contains a visual of ‘key areas’ to visually aid their typing.

In some embodiments, the methods described herein may display a visual guide. But, in some examples, evaluating patterns uses the anchoring information combined with relative location of indications to generate command signals.

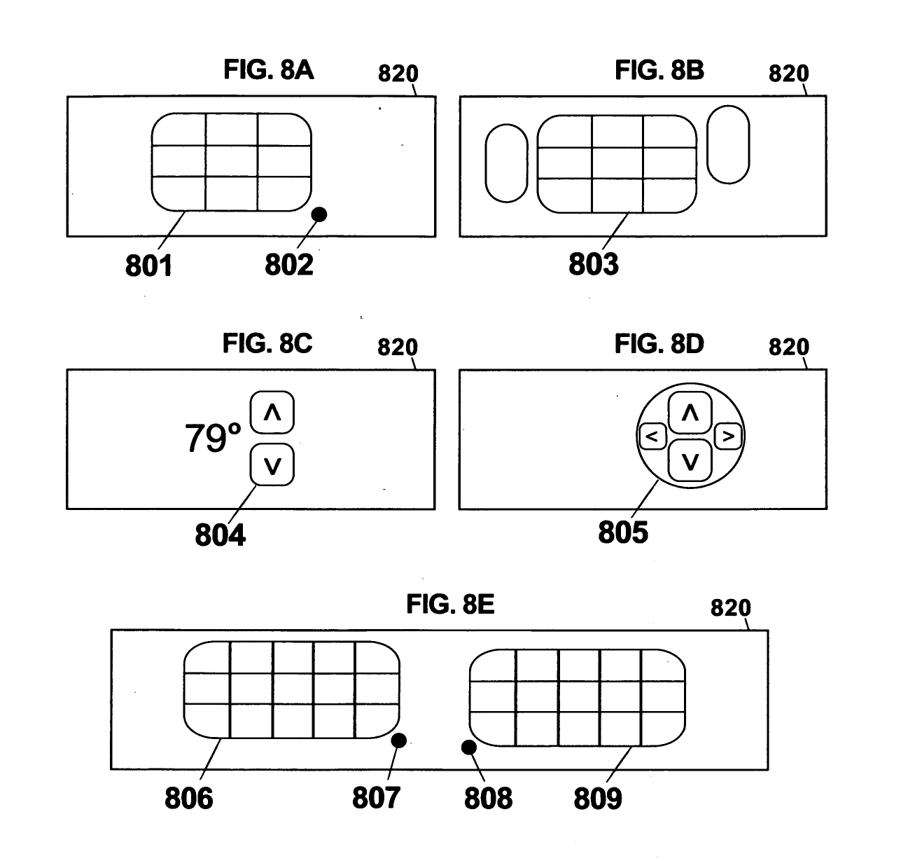

FIGS. 8A to 8E are diagrams illustrating exemplary implementations of the systems and methods described herein. There is an input-allowable area 820 in this example. These diagrams illustrate methods of displaying visual guides that appear under the user's hand to assist them in placing their fingers. In some embodiments, a visual guide may appear under the user's hand when she pattern-touches the correct configuration to indicate the beginning of typing. FIG. 8A is an illustration of a visual guide 801 for a typing system with a three×three grid for entering text. In this example, the user is holding a digit 802 to the surface to denote a held anchor. FIG. 8B is an illustration of a visual guide for a typing system with a three×three grid for entering text with separate guide ovals for side buttons that may correspond to the user moving in deformations and motions that move beyond the main grid area. For example, the right oval could correspond to the natural movement of passing the index finger to the right while holding the hand still. If this is placed on a surface, it might correspond to falling into the location of that right oval. The evaluations in determining the pattern would not use the oval in any way (e.g. the location, borders, placement) in determining the touch, rather it would evaluate relative to the anchor data. In this example, the anchor is not a digit held to the surface. FIG. 8C is an illustration of a visual guide 804 for entering temperature information on a wall panel. The evaluation of the input indications on the temperature controller may be relative to anchor data from a 3D sensor and not require any usage of key locations or fixed key areas in the analysis for generating a command signal that corresponds to the button displayed to the user. This decoupling of display and method of evaluation allows the user to have their indications evaluated for finger motion and current deformation state. FIG. 8C is an illustration of a visual guide 805 for a game controller. FIG. 8E is an illustration of a visual guide 806, 809 for entering two-handed typing. In this diagram, there are two held anchors 807, 808.

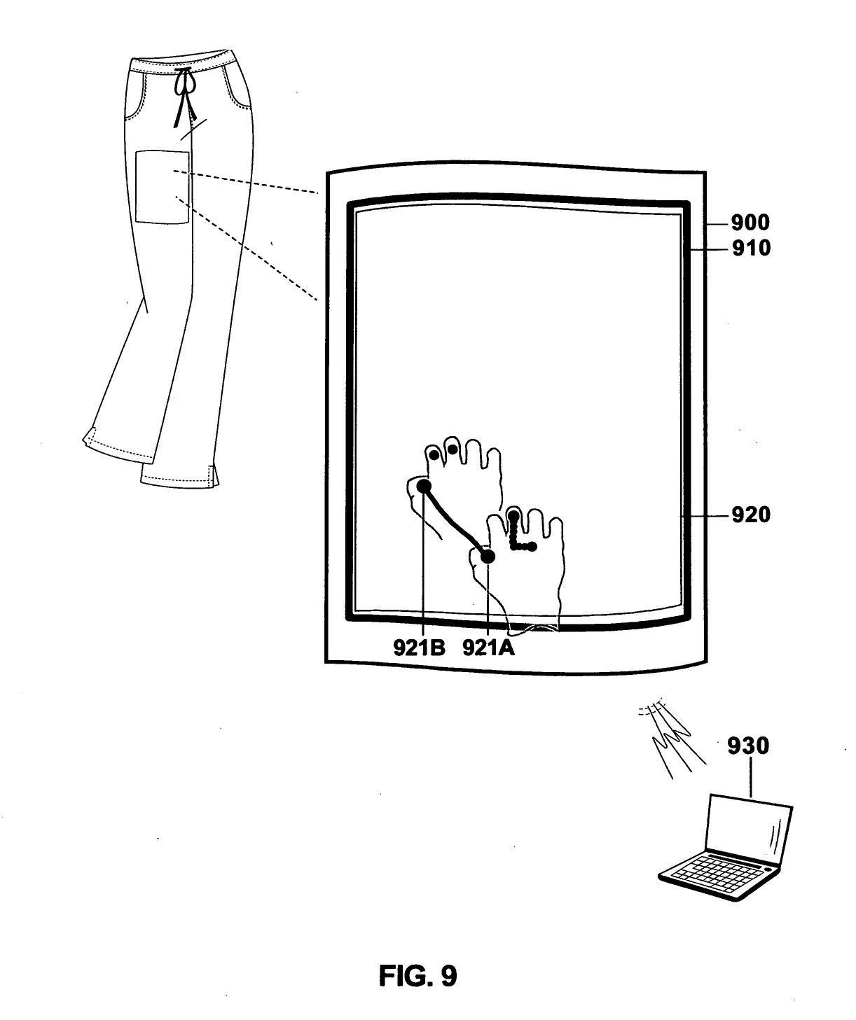

FIG. 9 is a diagram illustrating exemplary implementations of the systems and methods described herein. The diagram illustrates an example of an anchor-based pattern input-allowable area according to one or more aspects of the present disclosure. As shown in FIG. 9, computing device 900 may include touch-sensitive panel 910 and an input-allowable area 920. In this example, the input-allowable area is the full panel. A user's hand may contact touch-sensitive display 910 to type on the input-allowable area 920. In this example, there is a held thumb contact 921A, the location of which is stored in the anchor data. As the user moved his thumb, the diagram further illustrates the new position 921B of the held thumb contact. In this example, the user enters two separate patterns that correspond to two different command signals. Note that the user is typing without a visual display on the pants device. Note also that the nature of the device allows the user to easily put their hand down on any area of the presence-sensing surface and not have to ‘find’ a specific place to start typing. The pants device 900 communicates with a laptop computer 930. The pants device may send raw data that is interpreted by a program on the laptop computer. Or, the pants device may contain a program to interpret the patterns and communicate them to the laptop computer as an external keyboard would typically function.

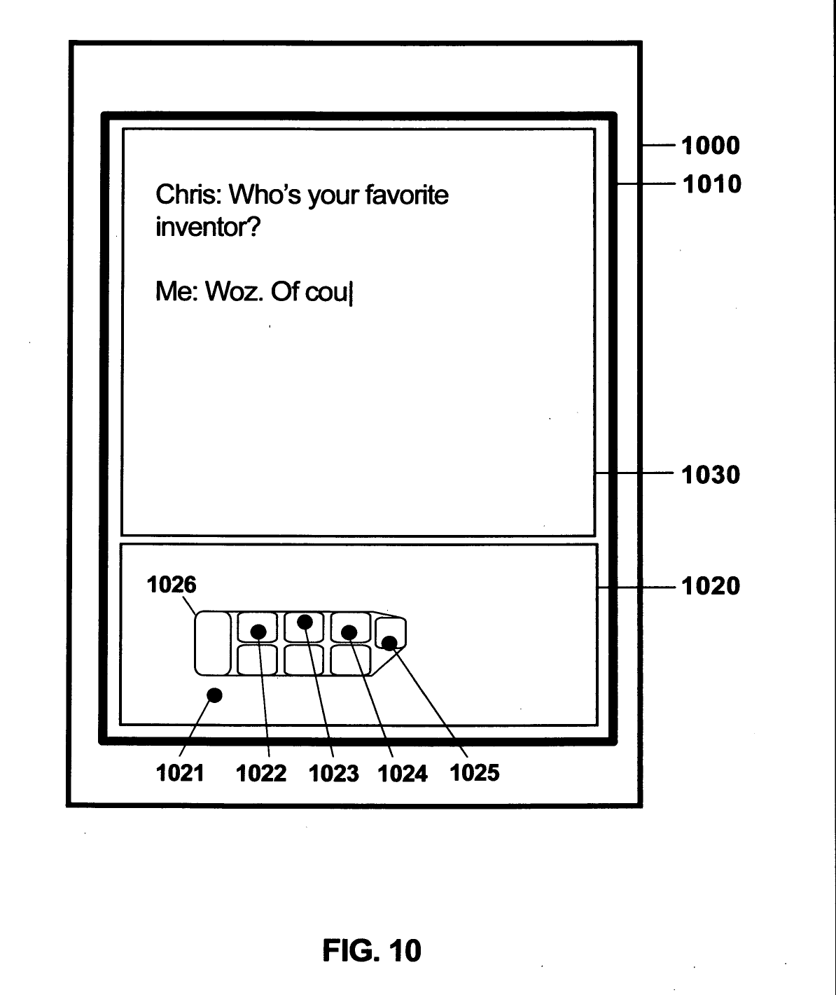

FIG. 10 is a diagram illustrating exemplary implementations of the systems and methods described herein. The diagram illustrates an example of an anchor-based pattern input-allowable area according to one or more aspects of the present disclosure. As shown in FIG. 10, computing device 1000 is a tablet that may include touch-sensitive display 1010 and an input-allowable area 1020. In this example, the input-allowable area is a portion of the touch-sensitive display. In this example, the user has placed all 5 digits 1021-1025 on the input-allowable area. The program displays a visual guide 1026. There is an area above for content display 130. This separation is in contrast, as some embodiments will have the input-allowable area and visual display overlapping content, as shown in FIG. 1. Note that the visual guide may make it appear to the user as if they are touching keys; but, in this example, the calculations of the touches are not using keys (e.g. key areas) in evaluating for data entry.

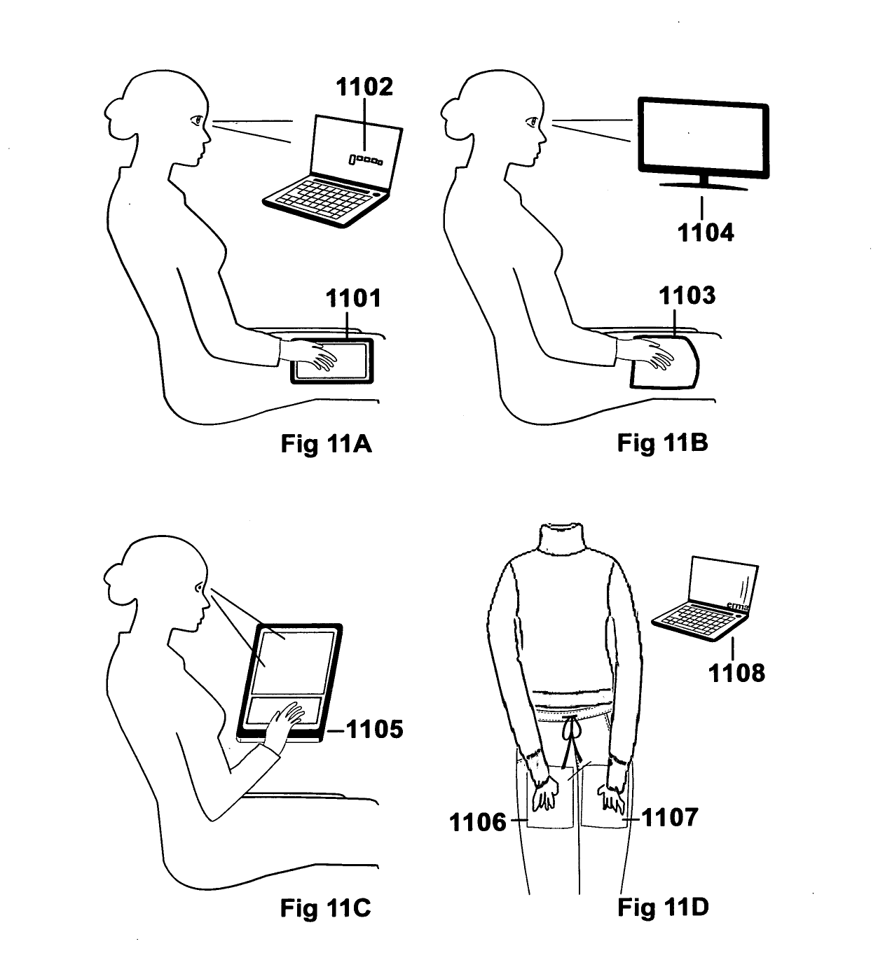

FIGS. 11A to 11D are diagrams illustrating exemplary implementations of the systems and methods described herein. These diagrams are examples that illustrate a user looking at the display for computer entry while entering data, in FIGS. 11A to 11C. FIG. 11A is an illustration of a user with a tablet 1101 on their lap communicating with a laptop that displays a visual guide 1102 on the laptop screen. In this example, the visual guide appears in an area where it would overlap content, and the visual guide would move with the user's hand as it moves on the tablet. FIG. 11B is an illustration of a user with a flexible device on their lap that contains a pattern set for tv controls 1103 communicating with a television 1104. FIG. 11C is an illustration of a user with a tablet device 1105 where the touches are detected on the touch-sensitive display. In this example, the user is touching to enter command signals such as text characters in a separate input-allowable area from the content display area on the screen. FIG. 11D is an example illustration of a user typing with their hands on a pants device comprising two separate presence sensitive components, which could be two separate devices 1106, 1107. These communicate to a laptop 1108. In this example, the user can enter text indication sets anywhere on the flexible patches (e.g. fabric-like). In other embodiments, (not shown) the pants could be made without patches visible to the user.

In some embodiments, an anchor may comprise set of spatial parameters in 3 dimensions (e.g. locations and sizes) relating to a user's hand. In some embodiments, the anchor may be static, for example, by holding a part of the hand against the surface. In some embodiments, the anchor may be physical. In some embodiments, the anchor data may be set based on video, motion or 3D sensing that may determine a surface.

In some embodiments, anchor information may be more complex than simply one or more coordinates.

In some embodiments, the anchor data is used when evaluating if a set of indications corresponds to a pattern by providing location information about the hand (e.g. points of location, span information) by which to determine the probability the indication set, as a whole, is placed closer or further away from the anchor or as relative to the anchor in some way.

In some embodiments, an anchor touch that is held may be lifted and put down again, with typing continuing without the need for the same anchor-initiating commands as the initial hand placement.

In some embodiments, the allowable input-allowable area may also used for other types of input (e.g. a mousepad), and a single finger may indicate mouse movement. In one example, if typing has just been happening when the type of input changes, the program may be able to distinguish that the held finger indicates restarting the typing and act accordingly.

In some embodiments, the anchoring may be extrapolated from previous touches or any sensing of the hand in general.

In some embodiments, the anchoring could use location (e.g. the midpoint of hand touches extrapolated from previous touches), size data, and angle of motion data (e.g. the angle at which the pinkie moves in relation to another axis) that are not related to a held touch. In some embodiments, the anchor might not have a held touch. In some embodiments, the anchor may correspond to a touch that was held during typing but has been lifted.

In some embodiments, the anchor can adjust values to improve pattern prediction according to the placement of indication as they occur, learning from how the user is placing their fingers and hand over time. This information may be stored for future use, not just during the runtime of the application containing methods in this disclosure.

In some embodiments, the sensing component may determine the anchor without an indication from the user. In some embodiments, the anchor may be determined by the indication of the user placing their hand in the sensing area.

In some embodiments, an anchor is used in conjunction with other sensing information (e.g. a video or 3d sensor sensing physical environmental elements) to figure the probability of an intended set of contacts corresponding to a pattern.

In some embodiments, the user may use four digits to perform indication sets and the anchor may be related to the span in which the indications are being performed. In this example, the anchor and any corresponding visual guide may move with the user's hand as it drifts.

In some embodiments, an anchor may contain location information based on previous indication sets.

In some embodiments, an anchor may change size information based on previous indication sets.

In some embodiments, the visual guide may be on a fixed area of the touch sensitive device.

In some embodiments, the visual guide may be static.

In some embodiments, the visual guide may resize its keys based on location information based on previous indication sets. ( . . . The anchor may be based on analysing the input indications of the patterns. This may take several patterning touch sets to figure out a midpoint or size.)

In some embodiments, the visual guide may resize its keys based on a change in the anchor's data relating to hand size.

In some embodiments, the anchor may be determined without regard to indication events.

In some embodiments, pattern analysis may involve accounting for the hand rotating on the screen and not being a match to the boundaries of the input-allowable area or the boundaries of the device.

In some embodiments, an indication can bring in alternate key layouts or change modes of the input-allowable area.

In some embodiments, a user may set their own pattern library

In some embodiments, there may be command signals defined for choosing a type of system (heating control panel or keyboard).

In some embodiments, visual guide layout may be based on QWERTY and may display letters.

In some embodiments, the visual guide may be displayed on a different device or display than the surface where the patterns are being entered.

In some embodiments, anchoring is started with an indication, but not held. For example, touching a thumb-related indication to start the anchoring, and lifting the thumb may be part of some embodiments.

In some embodiments, anchoring may set the anchor data based on location of the indications made as pattern entry.

In some embodiments, calculations may include axis or radial data for the anchor or patterning evaluations.

Some embodiments may include a wall computer interface, table interface, or other large surface and/or furniture related computer systems.

In some embodiments, the input-allowable area may also function as other input modes, which may be executed by the same and/or other programs. For example, some embodiments my change to a mouse area. In some embodiments, the lifting of all surface contacts may be instruct the program to consider a possible change in modes. In some examples, if the anchor comprises information on a hand palm contact, that may be excluded from the concept of lifting all surface contacts.

In some embodiments, relating indication sets back to the position of the anchor may comprise values outside of the anchor construct that relates to hand and finger position, even the primary anchoring finger if one exists.

In some embodiments, integrated into clothing might refer to a device attached to clothing. In some embodiments, integrated into clothing might refer to a device intended to be used in conjunction with clothing. In some embodiments, integrated into clothing might refer to a device that is intended to lay on top of clothing and conform to the contours of the clothing, which may be similar to how an attached patch functions.

Methods described herein, in some embodiments, may first identify a pattern type and then determine the digits performing the pattern by evaluating the pattern's location, as a whole, to the anchor for the result of determining a pattern.

Typically, a certain level of error tolerance may be built into identifying patterns in connection with the methods described herein. Such error tolerance may include treating the contacts in a probabilistic fashion or a deterministic fashion. Such determinations may be based on factors such as the locations of the contacts and the distance between the indications, patterns and anchors.

Embodiments also may be directed to computer program products comprising software stored on any computer-useable medium. Such software, when executed in one or more data processing device, causes a data processing device(s) to operate as described herein. Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments so fully reveals the general nature of the invention that others can, by applying knowledge within the skill of the art, readily modify and/or adapt for various applications such specific embodiments, without undue experimentation, without departing from the general concept of the present invention, Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The above sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

If a computing device has other uses for indications, touches or gestures performed by the methods herein, a person skilled in the art would be able to accommodate the potential conflicts that could arise in interpreting those indications, touches, or gestures in these methods.

Virtual buttons work in a similar manner to keys, but may or may not be associated with a keyboard. Examples in this disclosure with keys and keyboards are not intended to limit the methods in any way. For example, the methods described in this disclosure could apply to replacing ‘keying’ or ‘button pushing’ in any scenario that uses buttons (e.g. heating control wall panel with up and down buttons).

The foregoing description of the embodiments described herein provides illustration and description, but is not intended to be exhaustive or to limit the invention to the precise form disclosed. Modifications and variations are possible in light of the above teachings or may be acquired from practice of the invention.

For example, implementations have been described in the context of a tablet device. Implementations, however, may be used with any type of device with a presence-sensitive component that can be configured to identify user hand movement.

Aspects described herein may be implemented in methods and/or computer program products. Accordingly, aspects may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement these aspects is not limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include firmware, hardware—such as a processor, microprocessor, an application specific integrated circuit or a field programmable gate array—or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method for data input into a computing device, performed by a computing device operably coupled to at least one presence-sensitive component, the method comprising:
defining, by the computing device, an anchor based on data received by a presence-sensing component, comprising, at least in part, data relating to the location of a held indication on a surface wherein the held indication is performed by a hand;
receiving, by a presence-sensitive component, a set of input indications from the user;
identifying, by the computing device, a pattern by evaluating the set of input indications, based, if the set has more than one indication, at least in part, on spatial relation of input indications within the set of input indications, and evaluating based, at least in part, upon spatial relation of the set of input indications to the anchor,
identifying, by the computing device, a command signal that corresponds to the pattern;
performing, by the computing device, an action based on said command signal.

2. The method of claim 1, wherein the anchor comprises data relating to one or more of the following: size of the hand and size relating to input indications.

3. The method of claim 1, further comprising a visual guide that appears on a display and which corresponds to the user's hand location, and wherein the position of the visual guide is based, at least in part, on anchor data.

4. The method of claim 1, wherein a visual guide appears on a different surface than the surface where the indication sets are performed and wherein the position of the visual guide and/or the visual display of the visual guide corresponds to the performance of the indication sets by the user's hand.

5. The method of claim 1, further comprising a visual guide appears under the user's hand, and wherein the position of the visual guide is based, at least in part, on anchor data and wherein the visual guide overlaps displayed content.

6. The method of claim 1, wherein the held indication or the set of indications are indicated, at least in part, on an area of displayed content.

7. The method of claim 1, wherein at least part of the computing device is integrated into or intended to be used in conjunction with clothing.

8. The method of claim 1, further comprising identifying, based on data received by a presence-sensitive component, an indication set comprised of data relating to one or more digits touching a surface followed by all touches except one ending wherein the computing device triggers a command signal to initiate data entry in response to the identifying.

9. The method of claim 1, wherein the set of indications corresponds to placements of the user's hand intended to convey, conceptually, chorded typing wherein a pattern set is based on one of the following: a two-row and three-column grid, a three row and three column grid, a three row grid that utilizes a QWERTY concept.

10. A method for data input on a computing device, performed by a computing device operably coupled to at least one presence-sensitive component, the method comprising:
defining an anchor, by the computing device, based on data received by a presence-sensing component, comprising, at least in part, data relating to the location of a held indication on a surface wherein the held indication is performed by a hand;
detecting, by the computing device, based on data received by a presence-sensing component, a change of the held indication;
updating the anchor, by the computing device, based on data relating to a change of the location of the hand;
identifying, by the computing device, one or more input indications evaluated to correspond with a command signal;
performing an action, by the computing device, based on said command signal.

11. The method of claim 10, wherein the anchor comprises data relating to one or more of the following: size of the hand and size relating to input indications.

12. The method of claim 10, wherein a visual guide appears under the user's hand, and wherein the position of the visual guide is based, at least in part, on anchor data and wherein the visual guide moves location corresponding to anchor location changes.

13. The method of claim 10, wherein updating the anchor is based on the change of the held indication.

14. The method of claim 10, further comprising identifying an indication set, based on an indication set comprised of one or more digits touching a surface followed by all touches except one lifting and using the the location of the remaining held indication and wherein defining the anchor is based, at least in part, on the identified indication set.

15. A method for data input into a computing device, performed by a computing device operably coupled to at least one presence-sensitive component, the method comprising:
defining an anchor, by the computing device, based on data received by a presence-sensing component, comprising, at least in part, data relating to the location of a held indication on a surface wherein the held indication is performed by a hand;
receiving, by a presence-sensitive component, a set of input indications from the user;
identifying, by the computing device, a pattern by evaluating the set of input indications, based, if the set has more than one indication, at least in part, on spatial relation of input indications within the set of input indications, and evaluating based, at least in part, upon spatial relation of the set of input indications to the anchor;
identifying, by the computing device, a command signal that corresponds to the pattern;
performing, by the computing device, an action based on said command signal;
detecting, by the computing device, based on data received by a presence-sensing component, a change of the held indication;
updating, by the computing device, the anchor, based on data relating to the change of the held indication.

16. The method of claim 15, wherein the anchor comprises data relating to one or more of the following: size of the hand and size relating to input indications.

17. The method of claim 15, wherein a visual guide appears under the user's hand, and wherein the position of the visual guide is based, at least in part, on anchor data.

18. The method of claim 15, wherein a visual guide appears on a different surface than the surface where the indication sets are performed and wherein the position of the visual guide and/or the visual display of the visual guide corresponds to the performance of the indication sets by the user's hand.

19. The method of claim 15, wherein the held indication or the set of indications are indicated, at least in part, on an area of displayed content.

20. The method of claim 15, wherein at least part of the computing device is integrated into or intended to be used in conjunction with clothing.

21. The method of claim 15, further comprising identifying, based on data received by a presence-sensitive component, an indication set comprised of one or more digits touching a surface followed by all touches except one lifting and storing the location of the remaining held indication in the anchor.

22. The method of claim 15, wherein updating the anchor is based on input indications in the indication sets rather than data relating to the change of the held indication.

23. The method of claim 15, wherein the pattern evaluation includes first determining a pattern type then determining the pattern based, at least in part, on the location of the pattern as a whole to the anchor, and wherein the pattern evaluation is made without regard of direct comparison of the individual indications to the anchor.

24. The method of claim 14, wherein defining the anchor is based on a physical location on the presence-sensitive panel, without regard to data received by a presence-sensing component.

25. The method of claim 14, wherein the set of indications corresponds to placements of the user's hand intended to convey, conceptually, chorded typing wherein a pattern set is based on one of the following: a two-row and three-column grid, a three row and three column grid, a three row grid that utilizes a QWERTY concept.

26. A method for data input into a computing device, performed by a computing device operably coupled to at least one presence-sensitive component integrated with clothing, the method comprising:
defining, by the computing device, an anchor based on data received by a presence-sensing component, comprising, at least in part, data relating to the location of a held indication on a surface wherein the held indication is performed by a hand;
receiving, by a presence-sensitive component, a set of input indications from the user;
identifying, by the computing device, a pattern by evaluating the set of input indications, based, if the set has more than one indication, at least in part, on spatial relation of input indications within the set of input indications, and evaluating based, at least in part, upon spatial relation of the set of input indications to the anchor,
identifying, by the computing device, a command signal that corresponds to the pattern;
performing, by the computing device, an action based on said command signal.

27. The method of claim 26, further comprising a visual guide that appears on a display and which corresponds to the user's hand location, and wherein the position of the visual guide is based, at least in part, on anchor data.

28. The method of claim 26, further comprising identifying, based on data received by a presence-sensitive component, a set of indications comprised of data relating to one or more digits touching a surface followed by all touches except one ending wherein the computing device triggers a command signal to initiate data entry in response to the identifying.

29. The method of claim 26, further comprising identifying, based on data received by a presence-sensitive component, an indication set comprised of one or more digits touching a surface followed by all touches except one lifting and using the the location of the remaining held indication in defining the anchor.

30. The method of claim 26, wherein defining the anchor is based on a physical location on the presence-sensitive panel, without regard to data received by a presence-sensing component.

31. The method of claim 26, wherein the anchor comprises data relating to one or more of the following: size of the hand and size relating to input indications.

32. The method of claim 26, further comprising: updating, by the computing device, the anchor, based on data relating to the change of the held indication.

33. The method of claim 26, wherein the set of indications corresponds to placements of the user's hand intended to convey, conceptually, chorded typing wherein a pattern set is based on one of the following: a two-row and three-column grid, a three row and three column grid, a three row grid that utilizes a QWERTY concept.

34. A computing device that comprises:
one or more processors; and
at least one presence-sensitive component; and
a memory that stores instructions that, when executed by the one or more processors, configure the computing device to:
define an anchor based on data received by a presence-sensing component, comprising, at least in part, data relating to the location of a held indication on a surface wherein the held indication is performed by a hand;
receive, by a presence-sensitive component, a set of input indications from the user;
identify a pattern by evaluating the set of input indications, based, if the set has more than one indication, at least in part, on spatial relation of input indications within the set of input indications, and evaluating based, at least in part, upon spatial relation of the set of input indications to the anchor;
identify a command signal that corresponds to the pattern;
perform an action based on said command signal.

35. The computing device of claim 34, wherein the instructions, when executed by the one or more processors, configure the computing device to define anchor data relating to one or more of the following: size of the hand and size relating to input indications.

36. The computing device of claim 34, wherein the instructions, when executed by the one or more processors, configure the computing device to display a visual guide that appears on a display and which corresponds to the user's hand location, wherein the position of the visual guide is based, at least in part, on anchor data.

37. The computing device of claim 34, wherein the instructions, when executed by the one or more processors, configure the computing device to display a visual guide that appears on a different surface than the surface where the indication sets are performed and wherein the position of the visual guide and/or the visual display of the visual guide corresponds to the performance of the indication sets by the user's hand.

38. The computing device of claim 34, wherein the instructions, when executed by the one or more processors, configure the computing device to overlap the placement of the held indication or the set of indications on an area of displayed content.

39. The computing device of claim 34, wherein the instructions, when executed by the one or more processors, configure the computing device to identify, based on data received by a presence-sensitive component, an indication set comprised of data relating to one or more digits touching a surface followed by all touches except one ending wherein the computing device triggers a command signal to initiate data entry in response to the identifying.

40. A computing device that comprises:
one or more processors; and
at least one presence-sensitive component; and
a memory that stores instructions that, when executed by the one or more processors, configure the computing device to:
define an anchor based on data received by a presence-sensing component, comprising, at least in part, data relating to the location of a held indication on a surface wherein the held indication is performed by a hand;
receive, by a presence-sensitive component, a set of input indications from the user;
identify a pattern by evaluating the set of input indications, based, if the set has more than one indication, at least in part, on spatial relation of input indications within the set of input indications, and evaluating based, at least in part, upon spatial relation of the set of input indications to the anchor;
identify a command signal that corresponds to the pattern;
perform an action based on said command signal;
detect based on data received by a presence-sensing component, a change of the held indication;
update the anchor, based on data relating to the change of the held indication.

41. The computing device of claim 40, wherein the instructions, when executed by the one or more processors, configure the computing device to display a visual guide that appears under the user's hand, and wherein the position of the visual guide is based, at least in part, on anchor data.

42. The computing device of claim 40, wherein the instructions, when executed by the one or more processors, configure the computing device to display a visual guide that appears on a different surface than the surface where the indication sets are performed and wherein the position of the visual guide and/or the visual display of the visual guide corresponds to the performance of the indication sets by the user's hand.

43. The computing device of claim 40, wherein the instructions, when executed by the one or more processors, configure the computing device to, based on data received by a presence-sensitive component, identify an indication set comprised of one or more digits touching a surface followed by all touches except one lifting and store the location of the remaining held indication in the anchor.

44. The computing device of claim 40, wherein the instructions, when executed by the one or more processors, configure the computing device to evaluate a pattern by first determining a pattern type then determining the pattern based, at least in part, on the location of the pattern as a whole to the anchor, and wherein the pattern evaluation is made without regard of direct comparison of the the individual indications to the anchor.

45. The computing device of claim 40, wherein the instructions, when executed by the one or more processors, configure the computing device to define the anchor based on a physical location on the presence-sensitive panel, and without regard to data received by a presence-sensing component.

46. The computing device of claim 40, wherein the instructions, when executed by the one or more processors, configure the computing device to evaluate if the set of indications corresponds to placements of the users hand intended to convey, conceptually, chorded typing wherein a pattern set is based on one of the following: a two-row and three-column grid, a three row and three column grid, a three row grid that utilizes a QWERTY concept.

47. A computing device that comprises:
one or more processors; and
at least one presence-sensitive component integrated with clothing; and
a memory that stores instructions that, when executed by the one or more processors, configure the computing device to:
define an anchor based on data received by a presence-sensing component, comprising, at least in part, data relating to the location of a held indication on a surface wherein the held indication is performed by a hand;
receive, by a presence-sensitive component, a set of input indications from the user;
identify a pattern by evaluating the set of input indications, based, if the set has more than one indication, at least in part, on spatial relation of input indications within the set of input indications, and evaluating based, at least in part, upon spatial relation of the set of input indications to the anchor;
identify a command signal that corresponds to the pattern;
perform an action based on said command signal.

48. The computing device of claim 47, wherein the instructions, when executed by the one or more processors, configure the computing device to identify, based on data received by a presence-sensitive component, an indication set comprised of one or more digits touching a surface followed by all touches except one lifting and using the the location of the remaining held indication in defining the anchor.

49. The computing device of claim 47, wherein the instructions, when executed by the one or more processors, configure the computing device to update the anchor, based on data relating to the change of the held indication.

50. The computing device of claim 47, wherein the instructions, when executed by the one or more processors, configure the computing device to identify a set of indications that correspond to placements of the user's hand intended to convey, conceptually, chorded typing wherein a pattern set is based on one of the following: a two-row and three-column grid, a three row and three column grid, a three row grid that utilizes a QWERTY concept.
